(19) United States
(12) Patent Application Publication
(10) Pub. No.: US 2007/0000144 A1
(43) Pub. Date: Jan. 4, 2007

(54) Hot air towel warmer

(76) Inventor: John Beson, Houston, TX (US)

Correspondence Address: JOHN BESON, 10938 LEANING ASH LN., HOUSTON, TX, 77079, US

(21) Appl. No.: 11/171,989

(22) Filed: Jul. 1, 2005

(51) Int. Cl. F26B 19/00; F26B 25/06

(52) U.S. Cl. 34/201; 34/96

(57) ABSTRACT

An apparatus for drying and warming a towel or other articles includes a cabinet having an open top and a bar removably mounted across the top end of the cabinet. A towel to be dried and warmed is draped over the bar and suspended in the cabinet. Heated air, preferably supplied by a standard hair dried is introduced through an opening through the lower end of the cabinet. The open top of the cabinet provides for a bottom-to-top flow path for the heated air supplied to the cabinet. With the towel disposed in the flow path it is thereby heated by the air circulating therethrough by exposing both the inner surface and outer surface of the draped towel to the heated air.

### BACKGROUND OF THE INVENTION

The present invention pertains to a towel dryer and warming device that is free standing, simple in construction, simple to operate and suitable for use in the commercial market or individual homes. The simplicity of the device gives it a competitive edge. The device utilizes a commercially available portable hair dryer which dries and warms the towel in a relative short period of time. It is another important object of the present invention to provide a towel dryer and warming device which is adaptable to various models of hair dryers and can support and stabilize the hair dryer unit in operation without continuous attendance of the user.

U.S. Pat. No. 4,094,076 describes a fixture serving as a storage holster for a portable hair dryer and also functioning as a rack for drying towels.

U.S. Pat. No. 4,117,309 describes an electric towel warmer including an inverted, U-shaped rack which extends upwardly from the bottom of the cabinet or housing and is adapted to support a towel to be warmed. An electric heating element is mounted within the perforated rack.

U.S. Pat. No. 5,014,446 shows a towel warmer which comprises an enclosure with a support in the form of a perforated divider shelf arranged in the interior of the enclosure, dividing the enclosure into an upper volume and a lower volume. A towel is supported on the divider shelf and heated air is introduced into the lower volume and passes upwardly through the towel supported on the perforated divider shelf, with the air being vented through openings in the lid of the enclosure.

U.S. Pat. No. 5,606,640 describes a towel warmer in which a hollow rack is mounted within the upper portion of the cabinet and the towel is draped over the rack. Heated air is supplied through a standard electric hair dryer connected to an end of the rack by a locking mechanism. Heated air is directed over and through the rack then discharged downwardly and through the lower end of the cabinet.

### SUMMARY OF THE INVENTION

The invention is directed to an improved towel warmer which is simple in construction and operation and thus has particular application in hones.

In accordance with the invention, the towel warmer includes a cabinet or housing having an open top. A removable bar mounted across the top end of the cabinet and a towel to be heated is draped over the bar and introduced into the interior of the cabinet. Heated air is introduced through an opening through the lower end of one of the end walls of the cabinet and passes over the towel disposed in the air flow path and the towel is thereby heated by the air circulating therethrough and discharged through the open top of the cabinet. With the towel being loosely suspended in the air flow path, both the inner and outer surfaces of the towel is exposed to the heated air.

In a preferred form of the invention, the heated air is supplied by a standard portable electric hair dryer.

Due to the use of the heated air and the towel draped over the bar suspended loosely in the cabinet, both the inner and outer surfaces of the towel are heated, thereby increasing the efficiency of the heating operation and enabling a towel to be warmed is a short period of time.

The invention is simple in construction and is economical to produce making it affordable for individual home owner use. The towel warmer can be designed to be either free standing or wall mounted. The cabinet can be rectangular in shape or for aesthetic purposes can be oval or of some other configuration.

As a further feature of the invention, the hair dryer is held in place by a strap around the handle of the hair dryer with the ends of the strap removably secured to the side walls of the cabinet, allowing for easy replacement of the hair dryer.

Other objects and advantages will appear in the course of the following description.

### BRIEF DESCRIPTION OF DRAWING

The drawing illustrates the best mode presently contemplated of carrying out the Invention.

In the drawing:

FIG. 1 is a side view of the towel warmer of the invention;

FIG. 2 is a perspective view of the towel warmer cabinet;

FIG. 3 is a section view of the towel warmer taken along line 12-12 of FIG. 1;

### DETAILED DESCRIPTION OF THE INVENTION

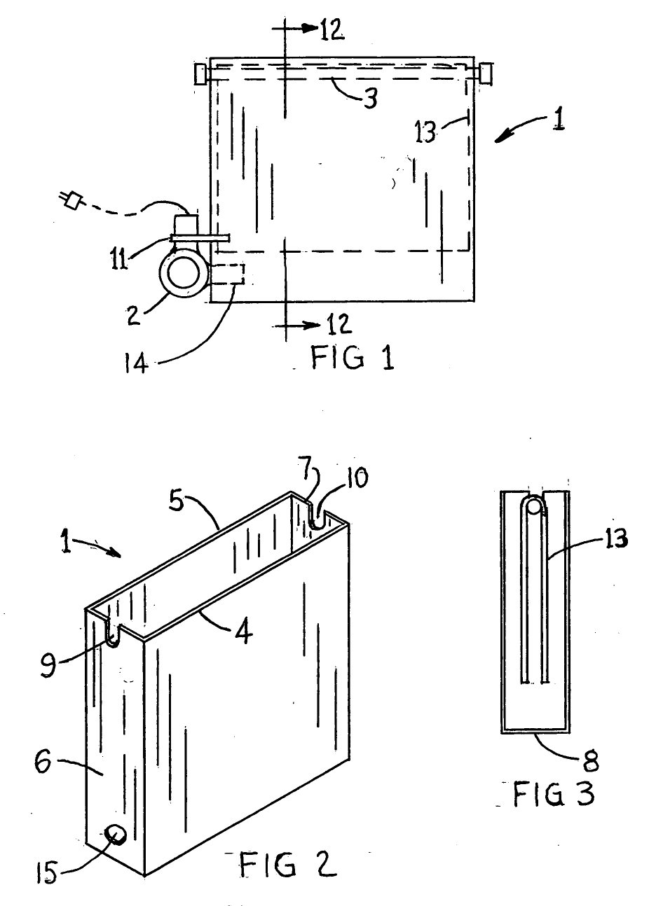

As shown in FIG. 1, a towel warming device broadly includes an enclosure 1, a forced air heating device 2, a strap 11 for securing the heating device to the enclosure 1, and a support rod 3. A towel 13, shown in phantom in FIG. 1, is draped over support rod 3.

Enclosure 1, as shown in FIG. 2 is composed of a front wall 4, a rear wall 5, a pair of end walls 6 and 7, and a bottom wall 8 shown in FIG. 3.

In the upper ends of walls 6 and 7 are vertical slots 9 and 10 configured to support, locate and retain rod 3.

A towel 13 shown in phantom in FIG. 1, and shown in section in FIG. 3, taken along line 12-12 of FIG. 1 is adapted to be draped over the length of rod 3 and placed into the interior of enclosure 1.

Heating device 2 includes a nozzle 14 which extends through an opening 15 formed in the lower end of wall 6 of enclosure 1, through which heated air is discharged in response to operation of heating device 2.

I claim:

1. A device for heating an article, comprising:
an enclosure with an open top providing access means to the interior thereof;
support means extending across the top of the said enclosure onto which said article is draped and suspended in the interior of the enclosure;
a nozzle extending into the lower end of the said enclosure for introducing under positive pressure heated air into the lower end of the enclosure, wherein the end of said nozzle is disposed below said support means for discharging heated air into the lower end of said enclosure;
an open top of said enclosure for venting air therefrom; wherein when said article is placed onto said support means, it is exposed to the flow of air provided by said nozzle to heat the article.

2. The device of claim 1, wherein said support means is a bar supported across the top of said enclosure.

3. The device of claim 2, wherein said support means is supported in locating slots in the top end of the enclosure.

4. The device of claim 1, wherein said heating means comprises a portable electric hair dryer.

5. The device of claim 4, wherein said device is held in place by a strap that is removably attached to the walls of the enclosure.

6. A device for heating an article, comprising:
an enclosure defined by a plurality of spaced walls, with an open top providing access means to the interior thereof;
support means extending between the top of the two end walls of said enclosure onto which said article is draped and suspended in the interior of the enclosure;
a nozzle extending into the lower end of one of the end walls for introducing under positive pressure heated air into the lower end of the enclosure, wherein the end of said nozzle is disposed below said support means for discharging heat air into the lower end of said enclosure;
an open top of said enclosure for venting air therefrom;
wherein, when said article is placed onto said support means it is exposed to the flow of air provided by said nozzle to heat the article.

7. The device of claim 2, wherein said support means is a bar supported in locating slots in the top of the end walls.

8. The device of claim 2, wherein said heating means comprises a portable electric hair dryer.

9. The device of claim 7, wherein said device is held in place by means that is removably attached to the side walls of the enclosure.
